(19) United States
(12) Patent Application Publication
(10) Pub. No.: US 2006/0109513 A1
(43) Pub. Date: May 25, 2006

(54) Multi-level halftoning apparatus and method

(75) Inventor: Hae-kee Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/283,734

(22) Filed: Nov. 22, 2005

(30) Foreign Application Priority Data
Nov. 24, 2004 (KR) 2004-96776

(51) Int. Cl. H04N 1/405

(52) U.S. Cl. 358/3.06

(57) ABSTRACT

A multi-level halftoning apparatus and method are provided. The multi-level halftoning apparatus includes a memory unit for storing a halftone table, and a comparison unit for determining a cell to be printed through comparison of an input tone with the stored halftone table. A sub-cell determined for printing after a reference main cell, which is a main cell in which a certain reference sub-cell is contained, becomes a sub-cell having the shortest distance from the reference sub-cell. The multi-level halftoning is processed based on distances between sub-cells constituting the halftone table so that cells determined for printing are optimally clustered, thereby improving the quality of printing.

### CROSS-REFERENCE TO RELATED APPLICATIONS

This application claims the benefit under 35 U.S.C. § 119(a) of Korean Patent Application No. 2004-96776, filed on Nov. 24, 2004, the entire contents of which are hereby incorporated by reference.

### BACKGROUND OF THE INVENTION

1. Field of the Invention

The present invention relates to a multi-level halftoning apparatus and a method thereof. More particularly, the present invention relates to a multi-level halftoning apparatus and a method of processing multi-level halftoning based on distances between sub-cells constituting a halftone table.

2. Description of the Related Art

Multi-level halftoning is a process for determining cells to be printed out of cells constructing a halftone table through a comparison of an input tone to the halftone table, and for outputting a determination result to which pulse width modulation (PWM) is applied. The halftone table for the multi-level halftoning is built with a plurality of super-cells. Furthermore, the multi-level halftoning of the input tone is performed in the unit of super cells.

On the other hand, one super cell is constituted with a plurality main cells, and one main cell is constructed with a plurality of sub-cells. Hereinafter, a ‘reference main cell’ is introduced to refer to a ‘main cell disposed in the center of the main cells constructing a super cell’, and a ‘reference sub-cell’ is also introduced to refer to a ‘sub-cell disposed in the center of the sub-cells constructing the reference main cell’.

FIG. 1 is a view showing a conventional allocation of threshold values of sub-cells constructing a super-cell. In FIG. 1, reference number 10 indicates a super cell constituting a halftone table, reference number 15 indicates the reference main cell, and reference number 15-2 indicates a reference sub-cell.

The multi-level halftoning process determines sub-cells to be printed from a sub-cell having the smallest allocated threshold value, that is, from the smallest to the largest. Thus, the reference sub-cell 15-2 is a sub-cell determined to be printed first out of the sub-cells constructing the super-cell 10 shown in FIG. 1. A sub-cell determined for printing after the determination of the reference sub-cell 15-2 is a sub-cell that has a threshold value of ‘2’, which is disposed on the left of the reference sub-cell 15-2. The following determination of sub-cells for printing is performed according to the threshold value assigned to the sub-cell.

Furthermore, in FIG. 1, a sub-cell first determined to be printed out of the sub-cells constructing the main cell is a sub-cell disposed in the center of the main cell, which is due to “being based on distances between the center of the main cells” when sub-cell threshold values are allocated. This is because the sub-cell threshold values are allocated in order that “a sub-cell determined for printing after the reference main cell 15 becomes a sub-cell disposed in the center of the main cell shortest in distance from the center of the reference main cell 15”.

As discussed above, the threshold value allocations cause the multi-level halftoning based on distances between the centers of the main cells constituting a halftone table, and such multi-level halftoning causes the following problems.

For example, when the input tone is ‘10’, ten sub-cells are determined in order from a sub-cell having the smallest threshold value, that is, from the smallest to the largest for printing out of the sub-cells shown in FIG. 1. The sub-cell having the allocated threshold value of ‘10’ is not adjacent to but spaced apart from the reference main cell 15. Therefore, a problem occurs that deteriorates a clustering rate of sub-cells determined to be printed, wherein the clustering refers to the gathering of cells determined to be printed.

Such clustering rate deterioration is produced due to the multi-level halftoning being based on the distances between the center of the main cells constructing a halftone table. The clustering rate deterioration causes print quality deterioration, so the clustering rate deterioration should be eliminated when the multi-level halftoning is applied.

Accordingly, a need exists for an improved apparatus for and a method of optimizing clustering of sub-cells to substantially prevent clustering rate deterioration to improve print quality.

### SUMMARY OF THE INVENTION

The present invention provides a multi-level halftoning apparatus and a method of processing multi-level halftoning based on distances between sub-cells constituting a halftone table, thereby obtaining optimal clustering.

The present invention has been developed to solve the above drawbacks and other problems associated with conventional arrangements. An aspect of the present invention is to provide a multi-level halftoning apparatus that has a memory unit for storing a halftone table, and a comparison unit for determining a cell to be printed through comparison of an input tone with the halftone table. The halftone table has a plurality of main cells, each of which contains a plurality of sub-cells. A sub-cell is determined for printing after a reference main cell, which is a main cell in which a predetermined reference sub-cell is contained, that becomes a sub-cell having the shortest distance from the reference sub-cell.

Preferably, of the sub-cells disposed around the reference main cell, a sub-cell determined for printing after the reference main cell is a sub-cell having the shortest distance from the center of the reference sub-cell.

Preferably, the halftone table is built with threshold values allocated to the sub-cells so that a sub-cell determined for printing after the reference main cell becomes a sub-cell having the shortest distance from the reference sub-cell.

Further, the sub-cells are produced by vertically dividing the main cell, and the sub-cell determined for printing after the reference main cell may be a sub-cell disposed on either the right side or the left side of the reference main cell.

Furthermore, a sub-cell determined for printing after the sub-cells disposed on the left and right sides of the reference main cell is a sub-cell disposed on any of upper and lower centers of the reference sub-cell.

Another aspect of the present invention is to provide a multi-level halftoning method for determining a cell to be printed through comparison of an input tone with a halftone table having a plurality of main cells, each of which contains a plurality of sub-cells. Printing of a reference main cell is determined, in which the reference main cell contains predetermined reference sub-cells. A sub-cell is determined that has the shortest distance from the reference sub-cell as a sub-cell to be printed after the reference main cell.

Preferably, of the sub-cells disposed around the reference main cell, a sub-cell determined for printing after the reference main cell is a sub-cell having the shortest distance from the center of the reference sub-cell.

Furthermore, the sub-cells are produced by vertically dividing the main cell. A sub-cell is determined for printing after the reference main cell may be a sub-cell disposed on either the right side or the left side of the reference main cell.

Furthermore, a sub-cell determined for printing after the sub-cells disposed on the left and right sides of the reference main cell is a sub-cell disposed on either the upper center or the lower center of the reference sub-cell.

Yet another aspect of the present invention is to provide a print device having a memory unit for storing a halftone table, and a comparison unit for determining a cell to be printed through comparison of an input tone with the halftone table. The halftone table is constituted with a plurality of main cells, each of which contains a plurality of sub-cells, and is built such that a sub-cell determined for printing after a reference main cell to which a predetermined reference sub-cell belongs becomes a sub-cell having the shortest distance from the reference sub-cell.

Other objects, advantages and salient features of the present invention will become apparent from the following detailed description, which, taken in conjunction with the annexed drawings, discloses exemplary embodiments of the present invention.

### BRIEF DESCRIPTION OF THE DRAWINGS

The above aspects and features of the present invention will be more apparent by describing certain exemplary embodiments of the present invention with reference to the accompanying drawings, in which:

FIG. 1 shows a conventional allocation state of threshold values of sub-cells constructing a super-cell;

FIG. 2 is a block diagram showing a multi-level halftoning apparatus according to an exemplary embodiment of the present invention;

FIG. 3A illustrates a method of disposing super-cells on a halftone table;

FIG. 3B is a view illustrating a method of allocating threshold values to sub-cells constituting a super-cell so that the sub-cells determined for printing are optimally clustered;

FIG. 3C illustrates a result of complete disposition of threshold values of sub-cells constructing the super-cells; and

FIG. 4 is a flow chart illustrating a multi-level halftoning method according to an exemplary embodiment of the present invention.

Throughout the drawings, like reference numerals will be understood to refer to like parts, components and structures.

### DETAILED DESCRIPTION OF EXEMPLARY EMBODIMENTS

Hereinafter, the present invention is described in detail with reference to the accompanying drawings.

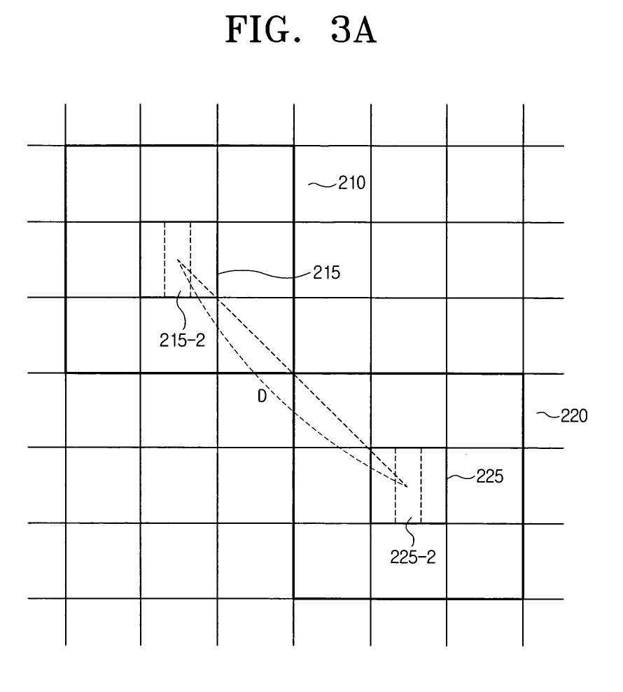

FIG. 2 is a block diagram showing a multi-level halftoning apparatus according to an exemplary embodiment of the present invention. The multi-level halftoning apparatus may process multi-level halftoning based on distances between sub-cells constituting a halftone table. The multi-level halftoning apparatus is provided with a comparison unit 110, a halftone table memory 120, and a PWM unit 130.

The comparison unit 110 determines which cells are to be printed out of the cells constituting a halftone table through a comparison of an ‘inputting tone’ (hereinafter, referred to as ‘input tone’) with a halftone table stored in the halftone table memory 120. The PWM unit 130 pulse-width-modulates and outputs a determination result of the comparison unit 110. A PWM signal outputted from the PWM unit 130 is used by a print unit (not shown) to perform print jobs on paper.

The halftone table stored in the halftone table memory 120 is built to enable multi-level halftoning based on distances between sub-cells constituting the halftone table, which is for the cells determined in order for printing to be optimally clustered. Hereinafter, a detailed description will be made of how the halftone table is built to enable the multi-level halftoning based on distances between sub-cells.

First, a determination is made of a halftone table size, a halftone table angle (format of main cells constituting a halftone table), a super-cell size, and halftoning levels. Next, i) the super-cells are disposed on the halftone table, and ii) threshold values are allocated to the sub-cells constituting the super-cell. By using the ‘void and cluster’ method, i) super-cells are disposed on the halftone table in order for the super-cells to be most evenly placed on the halftone table, and ii) threshold values are allocated to the sub-cells constituting the super-cells in order such that the cells determined for printing are optimally clustered.

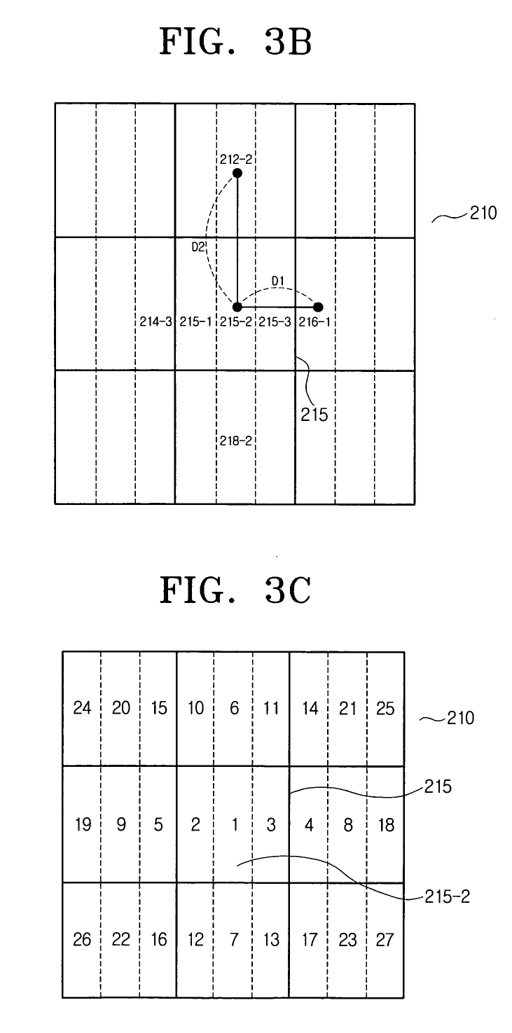

FIIG 3A is a view illustrating a method of most evenly disposing super-cells on a halftone table. In FIG. 3A, the format of main cells constituting the halftone table is configured to have a square shape, and a super-cell is configured to have nine main cells. Further, the halftoning levels are configured to have four levels, so that each main cell is configured to have three sub-cells vertically divided therein.

For the convenience of explanation, FIG. 3A shows part of the halftone table, that is, two super-cells 210 and 220. Furthermore, for the convenience of the drawings, of the main cells constituting the super-cells 210 and 220, FIG. 3A shows that only the main cells 215 and 225 disposed in the center of the super-cells 210 and 220 (hereinafter, referred to as a ‘reference main cell’) are vertically divided into three sub-cells. In the same manner, the other main cells, other than the reference main cells 215 and 225, are also vertically divided, although not shown.

To most evenly dispose super-cells on the halftone table, the super-cells are disposed such that the distances between the centers of the super-cells to become farthest. That is, the super-cells 210 and 220 shown in FIG. 3A are preferably disposed such that the distance D from the center of one cell to the center of the other cell to become farthest. The distance D between the centers of the super-cells 210 and 220 is substantially the same as the distance between the centers of the reference main cells 215 and 225 and the distance between the centers of the reference sub-cells 215-2 and 225-2. The ‘reference sub-cell’ refers to a ‘sub-cell disposed in the center of the sub-cells constituting the reference main cell’.

Thus, to most evenly dispose the super-cells on the halftone table, the super-cells are disposed to maximize the distance between the centers of the super-cells, the distance between the centers of the reference main cells, or the distance between the centers of the reference sub-cells.

FIG. 3B is a view illustrating a method of allocating threshold values to sub-cells constituting a super-cell so that the sub-cells determined for printing are optimally clustered. For the convenience of explanation, FIG. 3B shows only one of the super-cells constituting the halftone table, and in detail, FIG. 3B shows only the super-cell 210 of FIG. 3A.

Of the sub-cells constituting the super-cell 210 shown in FIG. 3B, a sub-cell first determined for printing is the reference sub-cell 215-2, and a sub-cell determined for printing after the reference sub-cell 215-2 is the sub-cell 215-1 disposed on the left of the ‘reference sub-cell 215-2’ (hereinafter, referred to as ‘sub-cell 215-1’). Further, a sub-cell determined for printing after the sub-cell 215-1 is the sub-cell 215-3 disposed on the right of the ‘reference sub-cell 215-2’ (hereinafter, referred to as ‘sub-cell 215-3’). Therefore, a threshold value of ‘1’ is allocated to the reference sub-cell 215-2, a threshold value of ‘2’ is allocated to the sub-cell 215-1, and a threshold value of ‘3’ is allocated to the sub-cell 215-3.

Alternatively, a sub-cell determined for printing after the reference sub-cell 215-2 may be the sub-cell 215-3 and a sub-cell determined for printing after the sub-cell 215-3 may the sub-cell 215-1. A threshold value of ‘2’ is allocated to the sub-cell 215-3, and a threshold value of ‘3’ is allocated to the sub-cell 215-1.

Hereinafter, description is made of the case that threshold values ‘1’, ‘2’, and ‘3’ are respectively allocated to the reference sub-cell 215-2, sub-cell 215-1, and sub-cell 215-3, respectively.

A sub-cell determined for printing after the reference sub-cell 215-2, sub-cell 215-1, and sub-cell 215-3 (that is, a sub-cell determined for printing after the reference main cell 215) is a sub-cell having the shortest distance from the reference sub-cell 215-2. Of the sub-cells disposed around the reference main cell 215, a sub-cell determined for printing after the reference main cell 215 is a sub-cell having the shortest distance from the reference sub-cell 215-2.

In FIG. 3B, the sub-cell having the shortest distance from the reference sub-cell 215-2 is a ‘sub-cell 216-1’ disposed on the right of the ‘reference main cell 215’ (hereinafter, referred to as ‘sub-cell 216-1’) or a ‘sub-cell 214-3’ disposed on the left of the ‘reference main cell 215’ (hereinafter, referred to as ‘sub-cell 214-3’). This is because the distance D1 between the sub-cells 216-1 and 214-3 disposed on the right and left of the reference main cell 215 is shorter than the distance D2 between the sub-cells cells 212-2 and 218-2 disposed in the centers of the upper and lower sides of the reference main cell 215.

Thus, a sub-cell determined for printing after the reference main cell 215 is the sub-cell 216-1 or the sub-cell 214-3. When the sub-cell 216-1 is first determined for printing out of the sub-cells -1 and 214-3, a threshold value of ‘4’ is allocated to the sub-cell 216-1, and then a threshold value of ‘5’ is allocated to the sub-cell 214-3.

A sub-cell determined for printing after the sub-cells 216-1 and 214-3 is a sub-cell having the next shortest distance from the center of the reference sub-cell 215-2. In FIG. 3B, a sub-cell having the next shortest distance from the center of the reference sub-cell 215-2 after the sub-cells 216-1 and 214-3 is a ‘sub-cell 212-2’ disposed in the center of the upper side of the ‘reference main cell 215’ (hereinafter, referred to as ‘sub-cell 212-2’) or a ‘sub-cell 218-2’ disposed in the center of the lower side of the ‘reference main cell 215’ (hereinafter, referred to as ‘sub-cell 218-2’). When the sub-cell 212-2 of the two sub-cells 212-2 and 218-2 is first determined to be printed, a threshold value of ‘6’ is allocated to the sub-cell 212-2, and a threshold value of ‘7’ is allocated to the sub-cell 218-2.

Thereafter, the remaining sub-cells are allocated with a threshold value in order of distances from the center from the reference sub-cell 215-2 to the respective sub-cells, that is, from the shortest to the longest. FIG. 3C shows a result of complete allocations of threshold values to the sub-cells constituting a super-cell according to the above method.

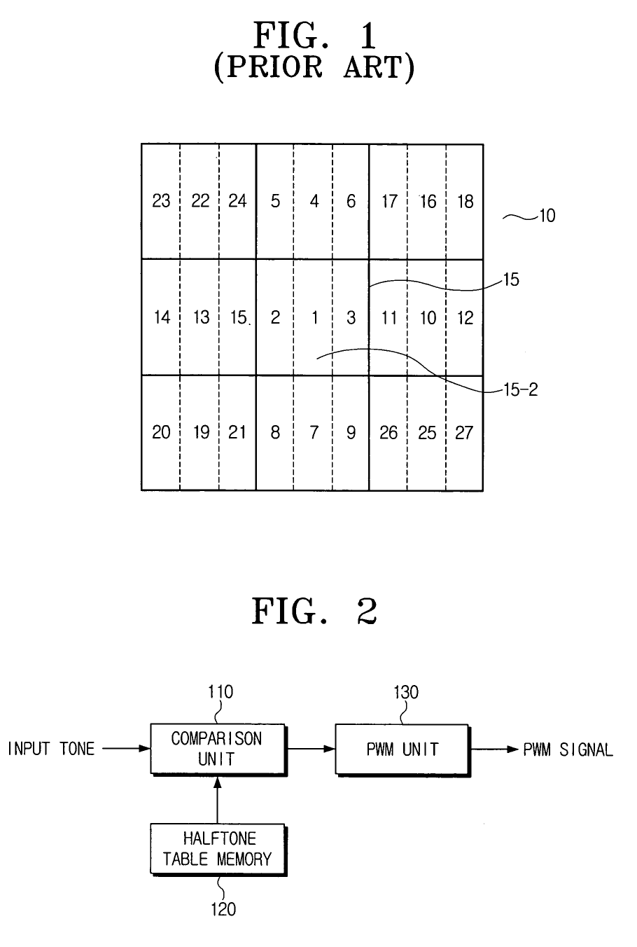

As shown in FIG. 3C, of the sub-cells constituting the main cell disposed on the right side of the reference main cell 215, a sub-cell first determined for printing is a ‘sub-cell disposed on the right side of the reference main cell 215’ (that is, a sub-cell allocated with a threshold value of ‘4’). When FIG. 1 is applied to prior art, a sub-cell first determined for printing out of the sub-cells constituting a main cell disposed on the right side of a reference main cell is a ‘sub-cell disposed in the center of the main cell disposed on the right side of the reference main cell’ (that is, a sub-cell allocated with a threshold value of ‘10’).

The multi-level halftoning described above with reference to FIG. 3C shows that the cells determined for printing are more optimally clustered. In FIG. 3C, the sub-cells are determined for printing in order of distances from the center of reference sub-cell 215-2 to the respective sub-cells, that is, from the shortest to the longest distances.

As shown in FIG. 3C, the threshold values of the sub-cells constituting a main cell disposed on the left and right sides or diagonally of the reference main cell 215 increases in the direction from the nearest sub-cell to the farthest sub-cell of the reference sub-cell 215-2, which is different from the case of FIG. 1 in which the threshold values of the sub-cells constituting a main cell increases for the sub-cells disposed on either side of the sub-cell disposed in the center of the main cell.

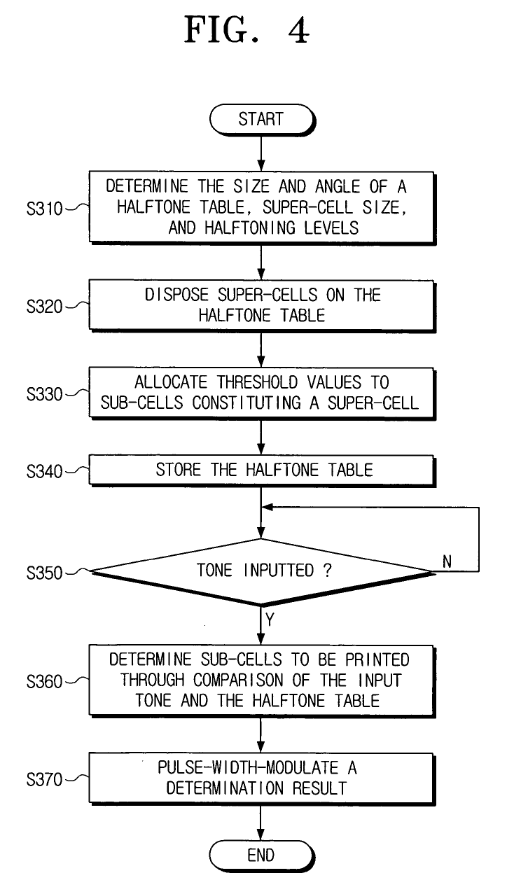

Hereinafter, a detailed description is made with respect to FIG. 4 on a multi-level halftoning process using a halftone table built to enable the multi-level halftoning based on distances from sub-cells.

First, a determination is made of a size of a halftone table to be built, an angle of the halftone table (the format of main cells constituting the halftone table), a super-cell size, and a halftoning level (S310). The super-cells are then disposed on the halftone table (S320).

Thereafter, threshold values are allocated to the sub-cells constituting the super-cells (S330). The threshold values are allocated to the sub-cells constituting the super-cells in order for the sub-cells determined for printing to be optimally clustered.

A sub-cell is determined for printing after the reference sub-cell 215-2, sub-cell 215-1, and sub-cell 215-3, that is, a sub-cell is determined for printing after the reference main cell 215 is allocated with a threshold value to have the shortest distance from the reference sub-cell 215-2. Of the sub-cells disposed around the reference main cell 215, a sub-cell is determined for printing after the reference main cell 215 is allocated with a threshold value to have the shortest distance from the center of the reference sub-cell 215-2. A threshold value is allocated to the remaining sub-cells, respectively, in order of distances from the center of the reference sub-cell 215-2, that is, from the shortest to the longest.

The halftone table is completely built through the steps S310 to S330 and is then stored in the halftone table memory 120 (S340).

Thereafter, when a tone is inputted (S350), the comparison unit 110 determines the sub-cells to be printed out of the sub-cells constituting the halftone table by comparing the input tone to the halftone table stored in the halftone table memory 120 (S360).

The step S360 uses the halftone table completely built through the steps S310 to S330, so the step S360 enables a sub-cell determined for printing after the reference main cell 215 to become a sub-cell having a distance shortest from the reference sub-cell 215-2. The step S360 also enables a next sub-cell determined for printing to become a sub-cell having the next shortest distance from the center of the reference sub-cell 215-2.

Next, the PWM unit 130 pulse-width-modulates and outputs a determination result of the comparison unit 110 (S370). Thereafter, the print unit (not shown) performs print jobs on paper, using a PWM signal outputted from the PWM unit 130.

As aforementioned, a description has been made of a method of performing the multi-level halftoning process based on the distances between sub-cells constituting the halftone table. In describing the exemplary embodiments of the present invention, the square shape has been considered as the format of the main cells constituting the halftone table, and the super-cell has been considered to have nine (9) main cells. Furthermore, the halftoning levels have been considered to be four levels, so that each main cell has been considered vertically divided into the three sub-cells. However, such considerations are merely provided as examples for ease of understanding of the exemplary embodiments of the present invention. Therefore, the present invention may be applied to main cells constituting the halftone table, the super-cell size, and the halftoning levels that are different from the above exemplary embodiments.

Furthermore, the present multi-level halftoning apparatus and method may be applied to print devices that print on paper data produced by themselves or that are externally received. The print devices may be copiers, printers, facsimile machines, combination devices incorporating them into one apparatus, and so on.

As described above, the present invention may process the multi-level halftoning based on distances between sub-cells constituting a halftone table so that cells determined for printing are optimally clustered. Furthermore, the optimal clustering as above contributes to print-quality improvement.

The foregoing embodiments and advantages are merely exemplary and are not to be construed as limiting the present invention. The present teaching may be readily applied to other types of apparatuses. Also, the description of the exemplary embodiments of the present invention is intended to be illustrative, and not to limit the scope of the claims, and many alternatives, modifications, and variations that will be apparent to those skilled in the art.

What is claimed is:

1. A multi-level halftoning apparatus, comprising:
a memory unit for storing a halftone table; and
a comparison unit for determining a cell to be printed by comparing an input tone with the halftone table, the halftone table being constituted of a plurality of main cells each of which contains a plurality of sub-cells, and the sub-cell determined for printing after a reference main cell, which is the main cell containing a predetermined reference sub-cell, is the sub-cell having the shortest distance from the reference sub-cell.

2. The multi-level halftoning apparatus as claimed in claim 1, wherein of the sub-cells disposed around the reference main cell, the sub-cell determined for printing after the reference main cell is the sub-cell having the shortest distance from the center of the reference sub-cell.

3. The multi-level halftoning apparatus as claimed in claim 1, wherein the halftone table is built with threshold values allocated to the sub-cells so that the sub-cell determined for printing after the reference main cell becomes the sub-cell having the shortest distance from the reference sub-cell.

4. The multi-level halftoning apparatus as claimed in claim 1, wherein the plurality of sub-cells are produced by vertically dividing the plurality of main cells, and the sub-cell determined for printing after the reference main cell is the sub-cell disposed on either the right side or the left side of the reference main cell.

5. The multi-level halftoning apparatus as claimed in claim 4, wherein the sub-cell determined for printing after the sub-cells disposed on the left and right sides of the reference main cell is the sub-cell disposed on any of upper and lower centers of the reference sub-cell.

6. The multi-level halftoning apparatus as claimed in claim 1, wherein a pulse width modulation unit pulse-width-modulates and outputs the determination result from the comparison unit.

7. A multi-level halftoning method of determining a cell to be printed by comparing an input tone with a halftone table having a plurality of main cells each of which contains a plurality of sub-cells, comprising steps of
determining printing of a reference main cell, which is the main cell containing predetermined reference sub-cells; and
determining the sub-cell having the shortest distance from the reference sub-cell as the sub-cell to be printed after the reference main cell.

8. The multi-level halftoning method as claimed in claim 7, wherein of the sub-cells disposed around the reference main cell, the sub-cell determined for printing after the reference main cell is the sub-cell having the shortest distance from the center of the reference sub-cell.

9. The multi-level halftoning method as claimed in claim 7, wherein the plurality of sub-cells are produced by vertically dividing the plurality of main cells; and
the sub-cell determined for printing after the reference main cell is the sub-cell disposed on either the right side or the left side of the reference main cell.

10. The multi-level halftoning method as claimed in claim 9, wherein the sub-cell next determined for printing is the other sub-cell of the sub-cells disposed on the right and left sides of the reference main cell.

11. The multi-level halftoning method as claimed in claim 10, wherein the sub-cell determined for printing after the sub-cells disposed on the left and right sides of the reference main cell is the sub-cell disposed on either the upper center or the lower center of the reference sub-cell.

12. The multi-level halftoning method as claimed in claim 11, wherein the sub-cell next determined for printing is the other sub-cell of the sub-cells disposed on the upper and lower centers of the reference sub-cell.

13. A print device, comprising:
a memory unit for storing a halftone table; and
a comparison unit for determining a cell to be printed by comparing an input tone with the stored halftone table, the halftone table being constituted of a plurality of main cells each of which contains a plurality of sub-cells, and built such that the sub-cell determined for printing after a reference main cell to which a predetermined reference sub-cell belongs is the sub-cell having the shortest distance from the reference sub-cell.

14. The multi-level halftoning apparatus as claimed in claim 13, wherein of the sub-cells disposed around the reference main cell, the sub-cell determined for printing after the reference main cell is the sub-cell having the shortest distance from the center of the reference sub-cell.

15. The multi-level halftoning apparatus as claimed in claim 13, wherein the halftone table is built with threshold values allocated to the sub-cells so that the sub-cell determined for printing after the reference main cell becomes the sub-cell having the shortest distance from the reference sub-cell.

16. The multi-level halftoning apparatus as claimed in claim 13, wherein the plurality of sub-cells are produced by vertically dividing the plurality of main cells, and the sub-cell determined for printing after the reference main cell is the sub-cell disposed on either the right side or the left side of the reference main cell.

17. The multi-level halftoning apparatus as claimed in claim 16, wherein the sub-cell next determined for printing is the other sub-cell of the sub-cells disposed on the right and left sides of the reference main cell

18. The multi-level halftoning apparatus as claimed in claim 17, wherein the sub-cell determined for printing after the sub-cells disposed on the left and right sides of the reference main cell is the sub-cell disposed on any of upper and lower centers of the reference sub-cell.

19. The multi-level halftoning apparatus as claimed in claim 18, wherein the sub-cell next determined for printing is the other sub-cell of the sub-cells disposed on the upper and lower centers of the reference sub-cell.

20. The multi-level halftoning apparatus as claimed in claim 13, wherein a pulse width modulation unit pulse-width-modulates and outputs the determination result from the comparison unit.
